(19) United States
(12) Patent Application Publication
(10) Pub. No.: US 2023/0415681 A1
(43) Pub. Date: Dec. 28, 2023

(54) POWER SUPPLY CONTROL DEVICE, IN-VEHICLE CONTROL DEVICE AND POWER SUPPLY CONTROL METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuma YAMANE, Yokkaichi-shi, Mie (JP)

(21) Appl. No.: 18/250,701

(22) PCT Filed: Oct. 13, 2021
(86) PCT No.: PCT/JP2021/037875

§ 371 Date: Apr. 26, 2023

(30) Foreign Application Priority Data
Oct. 28, 2020 (JP) 2020-180893

(51) Int. Cl. B60R 16/03; B60R 16/02

(52) U.S. Cl. CPC B60R 16/03; B60R 16/0207

(57) ABSTRACT

An individual ECU controls power supply through a plurality of wires. A microcomputer causes currents to flow through the plurality of wires. The microcomputer, if one wire temperature of the plurality of wires is a temperature threshold or more, reduces an average current value of a current flowing through a normal wire, of the plurality of wires, whose wire temperature is less than the temperature threshold.

### CROSS-REFERENCE TO RELATED APPLICATIONS

This application is the U.S. national stage of PCT/JP2021/037875 filed on Oct. 13, 2021, which claims priority of Japanese Patent Application No. JP 2020-180893 filed on Oct. 28, 2020, the contents of which are incorporated herein.

### TECHNICAL FIELD

The present disclosure relates to a power supply control device, an in-vehicle control device, and a power supply control method.

### BACKGROUND

JP 2014-204575A discloses a vehicle power supply control device that controls the supply of power from a DC power supply to a load via a wire. In this power supply control device, a switch is disposed on a path of current flowing through the wire. Power supply from the DC power supply to the load is controlled by switching the switch on or off. When the switch is on, a current flows from the DC power supply to the load via the wire, and the temperature of the wire increases. When the switch is off, the flow of current through the wire stops. Therefore, the wire temperature decreases.

The wire temperature is repeatedly calculated. If the wire temperature has increased to a temperature that is a cutoff threshold when the switch is on, the switch is switched off. Accordingly, the wire temperature is prevented from increasing to an abnormal temperature.

A plurality of loads that are to be started operating simultaneously are mounted in a vehicle. The driving of a vehicle may be impaired when all operations of a plurality of loads that are operated simultaneously stop. An example of the plurality of loads that are to be started operating simultaneously includes two head lights. When both head lights stop operating (emitting light) in a state in which the driver has not performed an operation to stop the operation thereof, driving of the vehicle may be impaired.

In a power supply control device that controls a plurality of loads that are to be started operating simultaneously, power is supplied to the plurality of loads through a plurality of wires, for example. A plurality of switches are disposed on respective current paths of currents that flow through the plurality of wires. Wire temperatures of the wires are calculated. If the wire temperature of one wire has increased to a temperature that is a cutoff threshold or more, the switch disposed on the current path of this wire is switched off. In this configuration, a case where all of the wire temperatures increase to a high temperature that is the cutoff threshold needs to be avoided as much as possible.

Therefore, the present disclosure aims to provide a power supply control device, an in-vehicle control device, and a power supply control method with which the likelihood that all of the wire temperatures will increase to a high temperature is low.

### SUMMARY

A power supply control device according to one aspect of the present disclosure is a power supply control device that controls power supply through a plurality of wires, and includes a processing unit configured to execute processing, wherein the processing unit causes currents to flow through the plurality of wires, and if one of wire temperatures of the plurality of wires is a temperature threshold or more, decreases an average current value of a current flowing through a normal wire, among the plurality of wires, whose wire temperature is less than the temperature threshold.

An in-vehicle control device according to one aspect of the present disclosure is an in-vehicle control device that controls operations of a plurality of loads, and includes: a receiving unit configured to receive instruction data for instructing that the plurality of loads be caused to start operating; and a processing unit configured to execute processing, wherein the processing unit, when the receiving unit has received the instruction data, causes currents to flow to the plurality of loads through a plurality of wires, and if one of wire temperatures of the plurality of wires has increased to a temperature that is a temperature threshold or more, decreases an average current value of a current flowing through a normal wire, among the plurality of wires, whose wire temperature is less than the temperature threshold.

A power supply control method according to one aspect of the present disclosure is a power supply control method that controls power supply through a plurality of wires, and the method causes a computer to execute: a step of causing currents to flow through the plurality of wires; and a step of, if one of wire temperatures of the plurality of wires has increased to a temperature that is a temperature threshold or more, decreasing an average current value of a current flowing through a normal wire, among the plurality of wires, whose wire temperature is less than the temperature threshold.

Note that the present disclosure can be realized not only as a power supply control device that includes such characteristic processing units, but also as a power supply control method that includes the characteristic processing as steps, or as a computer program for causing a computer to execute these steps. Also, the present disclosure can be realized as a semiconductor integrated circuit that realizes all or part of the power supply control device, or as a power supply control system that includes the power supply control device.

### Advantageous Effects of Disclosure

According to the present discloser, the likelihood that all of the wire temperatures will increase to a high temperature is low.

### BRIEF DESCRIPTION OF DRAWINGS

FIG. 1 is a block diagram illustrating the main configuration of a control system in a first embodiment.

FIG. 2 is a block diagram illustrating the main configuration of an individual ECU.

FIG. 3 is a block diagram illustrating the main configuration of a switching device.

FIG. 4 is a block diagram illustrating the main configuration of a microcomputer.

FIG. 5 is a diagram illustrating content of a wire temperature table.

FIG. 6 is a diagram illustrating content of a target value table.

FIG. 7 is a flowchart illustrating a procedure of wire temperature calculation processing.

FIG. 8 is a flowchart illustrating a procedure of power supply control processing for a load.

FIG. 9 is a flowchart illustrating a procedure of current reduction processing.

FIG. 10 is a flowchart illustrating a procedure of current reduction processing.

FIG. 11 is a timing chart illustrating an exemplary operation of the individual ECU.

FIG. 12 is a block diagram illustrating the main configuration of an individual ECU in a second embodiment.

FIG. 13 is a block diagram illustrating the main configuration of a microcomputer.

FIG. 14 is a flowchart illustrating a procedure of power supply control processing in a third embodiment.

FIG. 15 is a flowchart illustrating a procedure of current reduction processing.

FIG. 16 is a flowchart illustrating a procedure of current reduction processing.

### DETAILED DESCRIPTION OF PREFERRED EMBODIMENTS

Initially, modes for carrying out the disclosure will be enumerated and described. At least some of the modes described below may be combined as necessary.

### First Aspect

In accordance with a first aspect, a power supply control device according to one aspect of the present disclosure is a power supply control device that controls power supply through a plurality of wires, and includes a processing unit configured to execute processing, wherein the processing unit causes currents to flow through the plurality of wires, and if one of wire temperatures of the plurality of wires is a temperature threshold or more, decreases an average current value of a current flowing through a normal wire, among the plurality of wires, whose wire temperature is less than the temperature threshold.

### Second Aspect

In a second aspect, in the power supply control device according to one aspect of the present disclosure, when one of a plurality of wire temperatures is a cutoff threshold or more, the processing unit stops current flow through a wire whose wire temperature is the cutoff threshold or more, and the temperature threshold is less than the cutoff threshold.

### Third Aspect

In a third aspect, the power supply control device according to one aspect of the present disclosure further includes: a plurality of switches that are respectively disposed on current paths of currents flowing through the plurality of wires; and a plurality of switching circuits configured to respectively switch the plurality of switches on or off, wherein the processing unit causes currents to flow through wires by causing the switching circuits to perform PWM control on the respective switches to alternately switch on and off, and decreases an average current value of a current flowing through the normal wire by decreasing a duty ratio in the PWM control performed by the switching circuit of a switch corresponding to the normal wire.

### Fourth Aspect

In a fourth aspect, in the power supply control device according to one aspect of the present disclosure, currents flow to a plurality of loads from a DC power supply through the plurality of wires, and the processing unit acquires a voltage value of the DC power supply, calculates, with respect to each switching circuit, a duty ratio in the PWM control with which an average value of a related value related to the load matches a target value, based on the acquired voltage value, changes the duty ratio in the PWM control performed by the switching circuit to the calculated duty ratio, decreases the duty ratio in the PWM control by decreasing the target value of the load connected to the normal wire, and the related value is a current value of a current flowing to a load, a voltage value of a voltage applied to a load, or power supplied to a load.

### Fifth Aspect

In a fifth aspect, the power supply control device according to one aspect of the present disclosure further includes: a plurality of switches that are respectively disposed on current paths of currents flowing through the plurality of wires; and a plurality of switching circuits configured to respectively switch the plurality of switches on or off, wherein the processing unit causes currents to flow through wires by causing the switching circuits to respectively switch the switches on, and decreases an average current value of a current flowing through the normal wire by causing the switching circuit of a switch corresponding to the normal wire to perform PWM control to alternately switch the switch on and off.

### Sixth Aspect

In a sixth aspect, in the power supply control device according to one aspect of the present disclosure, the processing unit, after decreasing the average current value of the normal wire, if the wire temperature of an abnormal wire whose wire temperature increased to a temperature that is the temperature threshold or more has decreased to a temperature less than the temperature threshold, increases the average current value of the normal wire.

### Seventh Aspect

In a seventh aspect, in the power supply control device according to one aspect of the present disclosure, the processing unit, after decreasing the average current value of the normal wire, determines whether or not the average current value of the normal wire is to be further decreased, based on the wire temperature of the normal wire.

### Eighth Aspect

In an eighth aspect, in the power supply control device according to one aspect of the present disclosure, the processing unit acquires current values of currents flowing through the plurality of wires, and calculates a plurality of wire temperatures based on the plurality of acquired current values.

### Ninth Aspect

In a ninth aspect, an in-vehicle control device according to one aspect of the present disclosure is an in-vehicle control device that controls operations of a plurality of loads, and includes: a receiving unit configured to receive instruction data for instructing that the plurality of loads be caused to start operating; and a processing unit configured to execute processing, wherein the processing unit, when the receiving unit has received the instruction data, causes currents to flow to the plurality of loads through a plurality of wires, and if one of wire temperatures of the plurality of wires has increased to a temperature that is a temperature threshold or more, decreases an average current value of a current flowing through a normal wire, among the plurality of wires, whose wire temperature is less than the temperature threshold.

### Tenth Aspect

In a tenth aspect, in power supply control method according to one aspect of the present disclosure is a power supply control method that controls power supply through a plurality of wires, and the method causes a computer to execute: a step of causing currents to flow through the plurality of wires; and a step of, if one of wire temperatures of the plurality of wires has increased to a temperature that is a temperature threshold or more, decreasing an average current value of a current flowing through a normal wire, among the plurality of wires, whose wire temperature is less than the temperature threshold.

In the power supply control device, in-vehicle control device, and power supply control method according to one aspect described above, when one wire temperature has increased to a temperature that is a temperature threshold or more, an average current value of a current flowing through a normal wire whose wire temperature is less than the temperature threshold is reduced. Accordingly, the likelihood that the wire temperature of a normal wire will increase to a high temperature is low. As a result, the likelihood that all wire temperatures will increase to a high temperature is low.

In the power supply control device according to one aspect described above, when one wire temperature has increased to a temperature that is the cutoff threshold or more, the current flow through a wire whose wire temperature is cutoff threshold or more is stopped. Accordingly, the wire temperature will not increase to an abnormally high temperature.

In the power supply control device according to one aspect described above, as a result of the switching circuit performing PWM control, current flow through a wire is realized. By decreasing the duty ratio in PWM control performed by a switching circuit of the switch corresponding to a normal wire, the average current value of the normal wire is decreased.

In the power supply control device according to one aspect described above, the duty ratio in PWM control with which the average related value matches a target value is calculated based on the DC power supply voltage, and the duty ratio in the PWM control is changed to the calculated duty ratio. The target value of a load connected to a normal wire is reduced. With this, the duty ratio in the PWM control decreases, and the average current value of the normal wire decreases.

In the power supply control device according to one aspect described above, as a result of a switching circuit switching a switch on, a current flows through a wire. A switching circuit of the switch disposed on a current path of a current flowing through a normal wire performs PWM control, and as a result, the average current value of a current flowing through the normal wire decreases.

In the power supply control device according to one aspect described above, assume that the wire temperature of an abnormal wire has decreased to a temperature less than the temperature threshold, after the average current value of a normal wire has decreased. This means that the abnormal wire has returned to a normal wire. Therefore, when the wire temperature of an abnormal wire has decreased to a temperature less than the temperature threshold, the average current value of a normal wire is increased to an original average value, for example.

In the power supply control device according to one aspect described above, after decreasing the average current value of a normal wire, a determination is made as to whether or not the average current value of the normal wire is to be further reduced based on the wire temperature of the normal wire. Therefore, the likelihood that the wire temperature of a normal wire will increase to a high temperature is further reduced.

In the power supply control device according to one aspect described above, the wire temperature is calculated based on the current value of a current flowing through a wire.

Specific examples of a control system according to embodiments of the present disclosure will be described below with reference to the drawings. Note that the present disclosure is not limited to these illustrative examples and is defined by the claims, and all changes that come within the meaning and range of equivalency of the claims are intended to be embraced therein.

### First Embodiment

### Configuration of Control System

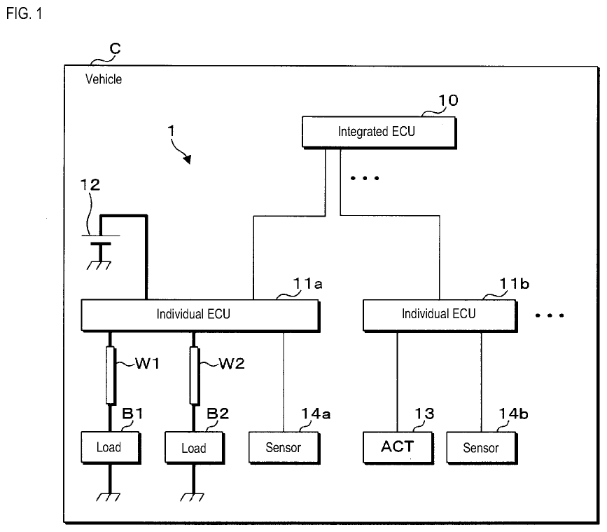

FIG. 1 is a block diagram illustrating the main configuration of a control system 1 in a first embodiment. The control system 1 is mounted in a vehicle C. The control system 1 includes an integrated ECU 10, an individual ECU 11a, a plurality of individual ECUs 11b, a DC power supply 12, an actuator 13, two sensors 14a and 14b, and two loads B1 and B2. The DC power supply 12 is a battery for example. In FIG. 1, interconnect lines for supplying power are shown with thick lines. Interconnect lines through which data or signals propagate are shown with thin lines.

The integrated ECU 10 is connected to the individual ECU 11a and the plurality of individual ECUs 11b. The individual ECU 11a is connected to a positive electrode of the DC power supply 12, one ends of two wires W1 and W2, and a sensor 14a. The other ends of the wires W1 and W2 are respectively connected to one ends of the loads B1 and B2. A negative electrode of the DC power supply 12 and the other ends of the loads B1 and B2 are grounded. An actuator 13 and a sensor 14b are connected to each individual ECU 11b.

The loads B1 and B2 are electrical devices. The individual ECU 11a causes the two loads B1 and B2 to start operating simultaneously. The individual ECU 11a stops the two loads B1 and B2 from operating simultaneously. Here, “simultaneously” does not only mean simultaneously in a strict sense. “Simultaneously” also means substantially simultaneously. Regarding operation of the two loads B1 and B2, if the difference between the timing at which a first load starts operating and the timing at which a second load starts operating is within an error range, the two loads B1 and B2 are considered to start operating substantially simultaneously. Regarding operation of the two loads B1 and B2 being stopped, if the difference between the timing at which a first load stops operating and the timing at which a second load stops operating is within an error range, the two loads B1 and B2 are considered to stop operating substantially simultaneously.

The actuator 13 is also an electrical device. The individual ECU 11b outputs a control signal indicating operations to be performed by the actuator 13 to the actuator 13. Upon receiving a control signal, the actuator 13 performs operations indicated by the received control signal.

The sensors 14a and 14b repeatedly generate vehicle data regarding the vehicle C. The vehicle data is image data obtained by capturing a surrounding area of the vehicle C, data indicating the speed of the vehicle C, data indicating whether or not a switch mounted on the vehicle C is on, or the like. Every time the sensor 14a generates vehicle data, the sensor 14a outputs the generated vehicle data to the individual ECU 11a. Similarly, every time the sensor 14b generates vehicle data, the sensor 14b outputs the generated vehicle data to the individual ECU 11b. Every time the individual ECUs 11a and 11b receive vehicle data, the individual ECUs 11a and 11b transmit the received vehicle data to the integrated ECU 10.

The integrated ECU 10 determines the operations of the two loads B1 and B2 based on one or more pieces of vehicle data received from at least one of the individual ECU 11a and the plurality of individual ECUs 11b. Here, the operations are to start operating or to stop operating. Upon determining the operations of the two loads B1 and B2, the integrated ECU 10 transmits instruction data for instructing the determined operations. Upon receiving instruction data from the integrated ECU 10, the individual ECU 11a causes the two loads B1 and B2 to perform the operations as instructed by the received instruction data.

Similarly, the integrated ECU 10 determines the operations of one or more actuators 13 based on one or more pieces of vehicle data received from at least one of the individual ECU 11a and the plurality of individual ECUs 11b. Upon determining the operations of the one or more actuators 13, the integrated ECU 10 transmits instruction data for instructing the determined operations to the corresponding to one or more individual ECUs 11b. Upon receiving instruction data from the integrated ECU 10, each individual ECU 11b outputs a control signal to the actuator 13 connected to the individual ECU 11b. The operations indicated by the control signal are operations instructed by the instruction data received by the individual ECU 11b. As mentioned above, the actuator 13 performs the operations indicated by the received control signal.

The DC power supply 12 supplies power to the load B1 through the individual ECU 11a and the wire W1. Furthermore, the DC power supply 12 supplies power to the load B2 through the individual ECU 11a and the wire W2. The individual ECU 11a controls power supply to the two loads B1 and B2 via the two wires W1 and W2. The individual ECU 11a functions as a power supply control device. When power is supplied to the load B1, the load B1 starts operating. When power supply to the load B1 stops, the load B1 stops operating. Similarly, when power is supplied to the load B2, the load B2 starts operating. When power supply to the load B2 stops, the load B2 stops operating.

The individual ECU 11a causes the two loads B1 and B2 to start operating simultaneously by supplying power to the two loads B1 and B2. The individual ECU 11a causes the two loads B1 and B2 to stop operating simultaneously by stopping power supply to the two loads B1 and B2.

As described above, the individual ECU 11a controls operations of the two loads B1 and B2 by controlling power supply to the two loads B1 and B2. The individual ECU 11a also functions as an in-vehicle control device.

The loads B1 and B2 are the same type of load. The loads B1 and B2 are head lights including LEDs (Light Emitting Diodes), head lights including incandescent lamps, windshield wiper motors for driving windshield wipers, or the like. The luminance value, rotational speed, or the like of the load B1 varies based on an average value of a related value regarding the load B1. Similarly, the luminance value, rotational speed, or the like of the load B2 varies based on an average value of a related value regarding the load B2. The average value is calculated by averaging the related values in a given period. A first example of the related value is a current value of the current supplied to the load B1 or B2. A second example of the related value is a voltage value of the voltage applied to the load B1 or B2. A third example of the related value is power supplied to the load B1 or B2.

Regarding a head light including LEDs, as the average current value of current flowing through the head light increases, the luminance value increases. Regarding a head light including an incandescent lamp, as the average value of power supplied to the head light increases, the luminance value increases. Regarding a windshield wiper motor, as the voltage value of the voltage applied to the windshield wiper motor increases, the rotational speed increases.

With respect to each of the loads B1 and B2, the individual ECU 11a adjusts the average value of the related values according to the voltage between two ends of the DC power supply 12. Below, the voltage between two ends of the DC power supply 12 is denoted as a power supply voltage. The individual ECU 11a repeatedly calculates the wire temperatures of the wires W1 and W2. The individual ECU 11a separately adjusts the current values of currents flowing through the wires W1 and W2 according to the calculated wire temperatures of the wires W1 and W2.

### Configuration of Individual ECU 11a

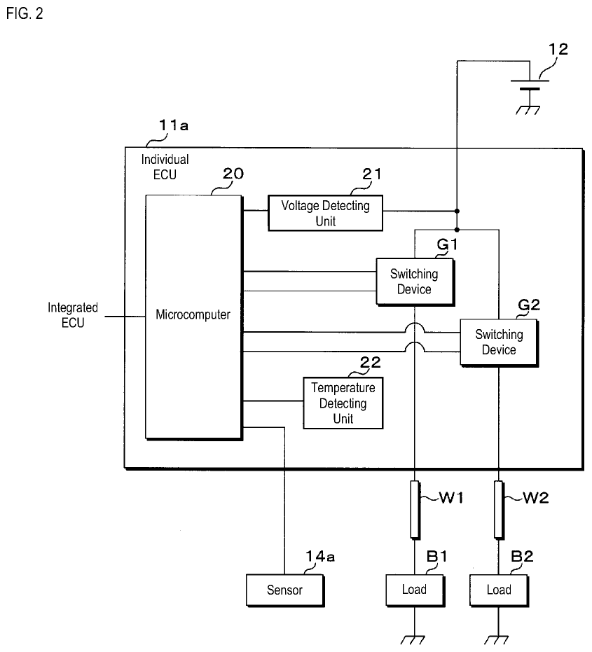

FIG. 2 is a block diagram illustrating the main configuration of the individual ECU 11a. The individual ECU 11a includes a microcomputer 20, a voltage detecting unit 21, a temperature detecting unit 22, and two switching devices G1 and G2. The switching devices G1 and G2 are connected to the positive electrode of the DC power supply 12. Furthermore, the switching devices G1 and G2 are respectively connected to one ends of the wires W1 and W2. The switching devices G1 and G2 are also connected to the microcomputer 20. The voltage detecting unit 21 is connected to the positive electrode of the DC power supply 12. The voltage detecting unit 21 and the temperature detecting unit 22 are connected to the microcomputer 20. The microcomputer 20 is also connected to the integrated ECU 10 and the sensor 14a.

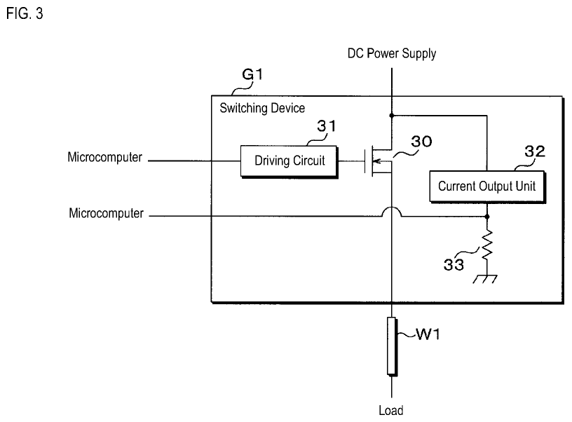

The switching device G1 includes a switch 30 (see FIG. 3). The switch 30 of the switching device G1 is disposed on a current path of current that flows from the positive electrode of the DC power supply 12 to the load B1. When the switch 30 of the switching device G1 is switched on, a current flows from the positive electrode of the DC power supply 12 to the switch 30, the wire W1, and the load B1 in this order. Accordingly, power is supplied to the load B1. When the switch 30 of the switching device G1 is switched off, the current flow stops, and the power supply to the load B1 stops.

The microcomputer 20 outputs a PWM (Pulse Width Modulation) signal or a low-level voltage to the switching device G1. The PWM signal includes high-level voltage periods and low-level voltage periods. In the PWM signal, switching from a low-level voltage to a high-level voltage is periodically performed. The duty ratio of a PWM signal is a ratio of a period, in one cycle, in which the voltage of the PWM signal is at the high-level voltage. The duty ratio exceeds zero and is one or less. The duty ratio is adjusted by adjusting the timing at which the signal is switched from the high-level voltage to the low-level voltage.

Note that, in the PWM signal, the signal may also be periodically switched from the high-level voltage to the low-level voltage. In this case, the duty ratio is adjusted by adjusting the timing at which the signal is switched from the low-level voltage to the high-level voltage.

In a case where the microcomputer 20 outputs the PWM signal to the switching device G1, when the PWM signal voltage is switched from the low-level voltage to the high-level voltage, the switching device G1 switches the switch 30 from off to on. In a similar case, when the PWM signal voltage is switched from the high-level voltage to the low-level voltage, the switching device G1 switches the switch 30 from on to off. The switching device G1 outputs analog current value information indicating the wire current of current flowing through the switch 30 and the wire W1 to the microcomputer 20. The current value information is a voltage proportional to the wire current of the wire W1, for example. When the microcomputer 20 outputs the PWM signal, power is supplied to the load B1.

When the microcomputer 20 outputs the low-level voltage, the switching device G1 keeps the switch 30 off. Therefore, when microcomputer 20 outputs the low-level voltage, the load B1 stops operating.

The switching device G2 includes a switch 30, similarly to the switching device G1. The microcomputer 20 outputs a PWM signal or a low-level voltage to the switching device G2. The switching device G2 functions similarly to the switching device G1. The function of the switching device G2 can be described by replacing the switching device G1, the load B1, and the wire W1 with the switching device G2, the load B2, and the wire W2, respectively, in the description of the function of the switching device G1. Therefore, the switching device G2 outputs the wire current value of the wire W2 to the microcomputer 20.

The voltage detecting unit 21 detects the power supply voltage of the DC power supply 12. The voltage detecting unit 21 outputs analog power supply voltage information indicating the detected power supply voltage to the microcomputer 20. The power supply voltage information is a voltage value obtained by voltage-dividing the power supply voltage, for example.

The temperature detecting unit 22 detects the environmental temperature. The environmental temperature is an ambient temperature of the wires W1 and W2. The temperature detecting unit 22 outputs analog environmental temperature information indicating the detected environmental temperature. The environmental temperature information is a voltage value that changes according to the environmental temperature, for example.

Every time the sensor 14a generates vehicle data, the sensor 14a outputs the generated vehicle data to the microcomputer 20.

The microcomputer 20 transmits the vehicle data input from the sensor 14a to the integrated ECU 10. The microcomputer 20 receives instruction data for instructing that the two loads B1 and B2 be caused to start or stop operations from the integrated ECU 10. Upon receiving instruction data for instructing that the two loads B1 and B2 be caused to start or stop operations, the microcomputer 20 outputs PWM signals to the two switching devices G1 and G2. Accordingly power is supplied to the two loads B1 and B2, and the two loads B1 and B2 start operating.

Upon receiving instruction data for instructing that the two loads B1 and B2 be caused to stop operations, the microcomputer 20 outputs a low-level voltage to the two switching devices G1 and G2. Accordingly, power supply to the two loads B1 and B2 stops, and the two loads B1 and B2 stop operating.

When outputting PWM signals to the switching devices G1 and G2, the microcomputer 20 adjusts the duty ratios of the PWM signals based on the power supply voltage value indicated by the power supply voltage information that is input from the voltage detecting unit 21. Also, the microcomputer 20 repeatedly calculates the wire temperature of the wire W1 based on the wire current of the wire W1 that is indicated by the current value information input from the switching device G1, the environmental temperature indicated by the environmental temperature information input from the temperature detecting unit 22, and the duty ratio of the PWM signal output to the switching device G1. Similarly, the microcomputer 20 repeatedly calculates the wire temperature of the wire W2 based on the wire current of the wire W2 that is indicated by the current value information input from the switching device G2, the environmental temperature indicated by the environmental temperature information input from the temperature detecting unit 22, and the duty ratio of the PWM signal output to the switching device G2.

The microcomputer 20 adjusts the duty ratios of the PWM signals output to the switching devices G1 and G2 based on the calculated wire temperatures of the wires W1 and W2. When the calculated wire temperature of the wire W1 has increased to a temperature that is a cutoff threshold or more, the microcomputer 20 outputs a low-level voltage to the switching device G1, and switches off the switch 30 of the switching device G1. Similarly, when the calculated wire temperature of the wire W2 has increased to a temperature that is the cutoff threshold or more, the microcomputer 20 outputs a low-level voltage to the switching device G2, and switches off the switch 30 of the switching device G2. The cutoff threshold is a fixed value, and is stored in a storage unit 44 in advance.

### Configuration of Switching Device G1

FIG. 3 is a block diagram illustrating the main configuration of the switching device G1. The switching device G1 includes the switch 30, a driving circuit 31, a current output unit 32, and a resistor 33. The switch 30 is an N-channel FET (Field Effect Transistor). The drain of the switch 30 is connected to a positive electrode of the DC power supply 12. The source of the switch 30 is connected to one end of the wire W1. As described above, the other end of the wire W1 is connected to one end of the load B1. The gate of the switch 30 is connected to the driving circuit 31. The driving circuit 31 is also connected to the microcomputer 20.

The current output unit 32 is also connected to the drain of the switch 30. The current output unit 32 is also connected to one end of the resistor 33. The other end of the resistor 33 is grounded. The connection node between the current output unit 32 and the resistor 33 is connected to the microcomputer 20.

When the gate voltage relative to the source potential is a given voltage or more, the switch 30 is on. When the switch 30 is on, a current can flow through the drain and source. When the gate voltage relative to the source potential is less than the given voltage, the switch 30 is off. When the switch 30 is off, a current cannot flow through the drain and source.

The microcomputer 20 outputs a PWM signal or a low-level voltage to the driving circuit 31. When the PWM signal voltage is switched from a low-level voltage to a high-level voltage, the driving circuit 31 increases the gate voltage of the switch 30 relative to the ground potential. Accordingly, in the switch 30, the gate voltage relative to the source potential increases to a voltage that is a given voltage or more, and the switch 30 is switched on. When the PWM signal voltage is switched from the high-level voltage to the low-level voltage, the driving circuit 31 decreases the gate voltage of the switch 30 relative to the ground potential. Accordingly, in the switch 30, the gate voltage relative to the source potential decreases to a voltage less than the given voltage, and the switch 30 is switched off.

As described above, when a PWM signal is output to the driving circuit 31, the driving circuit 31 performs PWM control for alternately switching the switch 30 on and off. The duty ratio in the PWM control indicates a ratio of a period, in a given period, in which the switch 30 is on. The duty ratio in the PWM control matches the duty ratio of the PWM signal.

When the microcomputer 20 outputs the low-level voltage to the driving circuit 31, the driving circuit 31 decreases the gate voltage of the switch 30 relative to the ground potential. Accordingly, the switch 30 is switched off.

The current output unit 32 draws in current from the drain of the switch 30, and outputs the drawn-in current to the resistor 33. The current value of current output by the current output unit 32 is proportional to the wire current of the wire W1, and is represented by a formula (wire current value of the wire W1)/(predetermined number). The voltage between two ends of the resistor 33 is output to the microcomputer 20 as the current value information. The current value information is presented by a voltage obtained using the formula (wire current value of the wire W1)·(resistance value of the resistor 33)/(predetermined number). The symbol “·” indicates multiplication. The resistance of the resistor 33 and the predetermined number are fixed values, and therefore, the current value information indicates the wire current of the wire W1.

### Configuration of Switching Device G2

The switching device G2 is configured similarly to the switching device G1. Therefore, the switching device G2 also includes a switch 30, a driving circuit 31, a current output unit 32, and a resistor 33. The microcomputer 20 outputs a PWM signal or a low-level voltage to the driving circuit 31 of the switching device G2. The configuration of the switching device G2 can be described by replacing the switching device G1 and the wire W1 with the switching device G2 and the wire W2, respectively, in the description of the configuration of the switching device G1. Accordingly, the current value information output by the switching device G2 includes a wire current value of the wire W2.

When the switch 30 of the switching device G1 is on, a current flows from the positive electrode of the DC power supply 12 through the switch 30 and the wire W1. When the switch 30 of the switching device G2 is on, a current flows from the positive electrode of the DC power supply 12 through the switch 30 and the wire W2. Accordingly, two switches 30 are disposed on paths of currents flowing through the two wires W1 and W2, respectively. In each of the two switching devices G1 and G2, the driving circuit 31 switches the switch 30 on or off. The driving circuits 31 of the switching devices G1 and G2 function as switching circuits.

### Configuration of Microcomputer 20

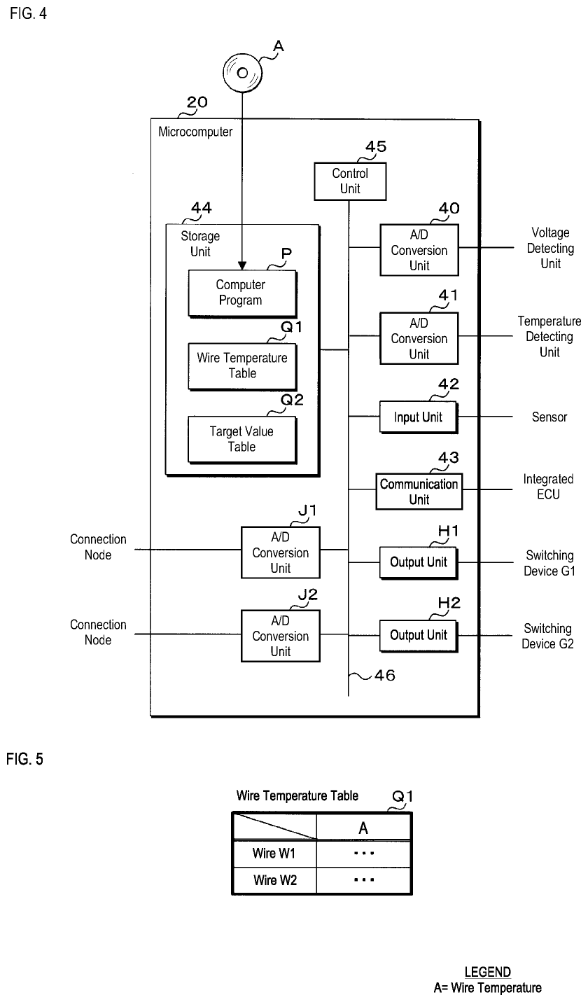

FIG. 4 is a block diagram illustrating the main configuration of the microcomputer 20. The microcomputer 20 includes A/D conversion units 40 and 41, an input unit 42, a communication unit 43, a storage unit 44, a control unit 45, two output units H1 and H2, and two A/D conversion unit J1 and J2. These units are connected to an internal bus 46. The A/D conversion units 40 and 41 are also connected to the voltage detecting unit 21 and the temperature detecting unit 22. The input unit 42 is also connected to the sensor 14a. The communication unit 43 is also connected to the integrated ECU 10. The output units H1 and H2 are respectively also connected to the driving circuits 31 of the switching devices G1 and G2. The A/D conversion unit J1 and J2 are respectively also connected to connection nodes of the switching devices G1 and G2.

Analog power supply voltage information is input to the A/D conversion unit 40 from the voltage detecting unit 21. The A/D conversion unit 40 converts the input analog power supply voltage information to digital power supply voltage information. The control unit 45 acquires the digital power supply voltage information from the A/D conversion unit 40.

Analog environmental temperature information is input to the A/D conversion unit 41 from the temperature detecting unit 22. The A/D conversion unit 41 converts the input analog environmental temperature information to digital environmental temperature information. The control unit 45 acquires the digital environmental temperature information from the A/D conversion unit 41.

The sensor 14a repeatedly outputs vehicle data to the input unit 42.

The communication unit 43 transmits vehicle data to the integrated ECU 10 in accordance with an instruction from the control unit 45. The communication unit 43 receives instruction data for instructing that the two loads B1 and B2 be caused to start or stop operating from the integrated ECU 10. The communication unit 43 functions as a receiving unit.

The output units H1 and H2 output PWM signals to the driving circuits 31 of the switching devices G1 and G2, respectively, in accordance with instructions from the control unit 45. The duty ratios of the PWM signals respectively output from the output units H1 and H2 are adjusted by the control unit 45. The output units H1 and H2 also output a low-level voltage to the driving circuits 31 of the switching devices G1 and G2, in accordance with the instructions from the control unit 45.

Pieces of analog current value information are respectively input to the A/D conversion units J1 and J2 from connection nodes of the switching devices G1 and G2. The A/D conversion units J1 and J2 each convert the input analog current value information to digital current value information. The control unit 45 acquires the digital current value information from each of the A/D conversion units J1 and J2. The pieces of current value information acquired from the A/D conversion units J1 and J2 respectively indicate the wire currents of the wires W1 and W2.

The storage unit 44 is a nonvolatile memory A computer program P is stored in the storage unit 44. The control unit 45 includes a processing element that executes processing, such as a CPU (Central Processing Unit). The control unit 45 functions as a processing unit. The processing element of the control unit 45 executes, in parallel, vehicle data transmission processing, two sets of temperature calculation processing, two sets of power supply control processing, current reduction processing, and the like, by executing the computer program P.

The vehicle data transmission processing is processing for transmitting vehicle data to the integrated ECU 10. The two sets of temperature calculation processing are sets of processing for calculating the respective wire temperatures of the wires W1 and W2. The two sets of power supply control processing are sets of processing for controlling power supply to the loads B1 and B2, respectively. The current reduction processing is processing for reducing the wire current of one of the wires W1 and W2.

Note that the computer program P may also be stored in a non-transitory storage medium A such that the processing element of the control unit 45 can read the computer program P. In this case, the computer program P read out from the storage medium A by a reading device (not shown) is written into the storage unit 44. The storage medium A is an optical disk, a flexible disk, a magnetic disk, a magneto-optical disk, a semiconductor memory or the like. The optical disk is a CD (Compact Disc)-ROM (Read Only Memory), a DVD (Digital Versatile Disc)-ROM, a BD (Blu-ray (registered trademark) Disc), or the like. The magnetic disk is a hard disk, for example. Also, the computer program P may also be downloaded from an external device (not shown) that is connected to a communication network (not shown), and the downloaded computer program P may be written into the storage unit 44.

The number of processing elements included in the control unit 45 is not limited to one, and may also be two or more. When the number of processing elements included in the control unit 45 is two or more, the plurality of processing elements execute the vehicle data transmission processing, the two sets of temperature calculation processing, the two sets of power supply control processing, the current reduction processing, and the like, in a cooperated manner.

The control unit 45 periodically executes each of the two sets of temperature calculation processing. In the two sets of temperature calculation processing, the control unit 45 calculates the wire temperatures of the wires W1 and W2, respectively. In each of the two sets of temperature calculation processing, the control unit 45 calculates the temperature difference between the wire temperature and the environmental temperature.

In the calculation of the wire temperature of the wire W1, the control unit 45 calculates a temperature difference ΔTw by substituting a prior temperature difference ΔTp that was calculated previously, a wire current Iw of the wire W1, an environmental temperature Ta, and a duty ratio D of the PWM signal in the following formulas [1], [2].

ΔTw=ΔTp·exp(−Δt/Tr)+Rth·Rw·D·Iw²·(1−exp(−Δt/tr)) [1]

Rw=Ro·(1+K·(Ta+ΔTp−To)) [2]

The variables and constants used in the formulas [1] and [2] will be described. In the description of the variables and constants, the units of the variables and constants are also shown. ΔTw, ΔTp, Ta, Iw, Rw, Rth, and D are respectively a calculated temperature difference (° C.), a prior temperature difference (° C.), an environmental temperature (° C.), a wire current (A) of the wire W1, a wire resistance (Q) of the wire W1, a wire thermal resistance (° C./W) of the wire W1, and a duty ratio of the PWM signal, as described above. At is a cycle (s) with which the temperature difference ΔTw is calculated, that is, a cycle with which the temperature calculation processing is executed. tr is a wire heat release time constant (s) of the wire W1.

To is a predetermined temperature (° C.). Ro is a wire resistance (Q) at the temperature To. K is a wire resistance temperature coefficient (/° C.) of the wire W1. The temperature difference ΔTw, prior temperature difference ΔTp, wire current Iw, and environmental temperature Ta are variables. The cycle Δt, wire heat release time constant tr, wire thermal resistance Rth, wire resistance Ro, wire resistance temperature coefficient K, and temperature To are preset constants.

The value of the first term in the formula [1] decreases as the cycle Δt increases, and therefore the first term of the formula [1] represents heat released from the wire W1. Also, the value of the second term of the formula [1] increases as the cycle Δt increases, and therefore, the second term of the formula [1] represents the heat generated by the wire W1.

The control unit 45 calculates the wire temperature of the wire W2 similarly to the wire temperature of the wire W1.

Two prior temperature differences regarding the two wires W1 and W2 are stored in the storage unit 44. The two prior temperature differences are changed by the control unit 45. Also, a wire temperature table Q1 showing the wire temperatures of the wires W1 and W2 is stored in the storage unit 44.

FIG. 5 is a diagram illustrating content of the wire temperature table Q1. As shown in FIG. 5, the wire temperatures of the wires W1 and W2 are shown in the wire temperature table Q1. The wire temperatures shown in the wire temperature table Q1 are changed by the control unit 45.

In the two sets of power supply control processing, the control unit 45 adjusts the average values of related values related to the respective loads B1 and B2 to target values. In the current reduction processing, the control unit 45 changes at least one of the target values. The wires W1 and W2 are associated with the loads B1 and B2, respectively. A target value table Q2 showing two target values for the two loads B1 and B2 and two initial values of the two target values is stored in the storage unit 44.

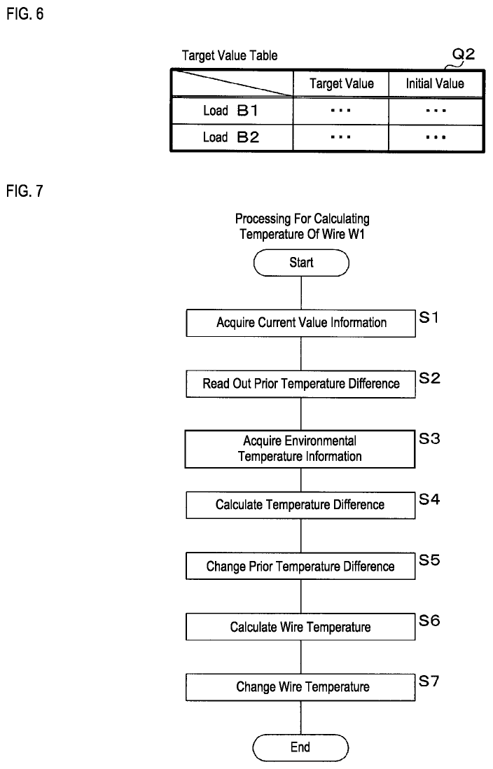

FIG. 6 is a diagram illustrating content of the target value table Q2. As shown in FIG. 6, two target values for the two loads B1 and B2 and two initial values of the two target values are shown in the target value table Q2. The two target values shown in target value table Q2 are changed by the control unit 45.

### Vehicle Data Transmission Processing

In the vehicle data transmission processing, the control unit 45 waits until vehicle data is input to the input unit 42 from the sensor 14a. When vehicle data is input to the input unit 42, the control unit 45 acquires the vehicle data input to the input unit 42. Next, the control unit 45 instructs the communication unit 43 to transmit the acquired vehicle data to the integrated ECU 10, and ends vehicle data transmission processing. After ending the vehicle data transmission processing, the control unit 45 again executes the vehicle data transmission processing.

### Processing for Calculating Temperature of Wire W1

FIG. 7 is a flowchart illustrating a procedure of processing for calculating the temperature of the wire W1. The control unit 45 periodically executes the processing for calculating the temperature of the wire W1. In the processing for calculating the temperature of the wire W1, the control unit 45 acquires current value information indicating the wire current of the wire W1 from the A/D conversion unit J1 (step S1). Once the output unit H1 outputs a duty ratio of the PWM signal, the control unit 45 acquires the current value information in a period in which the PWM signal is at a high-level voltage. Next, the control unit 45 reads out a prior temperature difference of the wire W1 from the storage unit 44 (step S2). This prior temperature difference is a temperature difference calculated in the previous temperature calculation processing. After executing step S2, the control unit 45 acquires environmental temperature information from the A/D conversion unit 41 (step S3).

The control unit 45 calculates the temperature difference between the environmental temperature and the wire temperature of the wire W1 by substituting a plurality of numerical values in the formulas [1] and [2] with other numerical values (step S4). The plurality of numerical values are a wire current of the wire W1 indicated by the current value information acquired in step S1, a prior temperature difference read out in step S2, an environmental temperature indicated by the environmental temperature information acquired in step S3, and a duty ratio of the PWM signal output by the output unit H1. When the output unit H1 is outputting a low-level voltage, the duty ratio is zero. Next, the control unit 45 changes the prior temperature difference stored in the storage unit 44 to the temperature difference calculated in step S4 (step S5). The changed prior temperature difference is used next time temperature calculation processing is performed. After executing step S5, the control unit 45 calculates the wire temperature of the wire W1 by adding the temperature difference calculated in step S4 to the environmental temperature indicated by the environmental temperature information acquired in step S3 (step S6).

Next, the control unit 45 changes the wire temperature of the wire W1 in the wire temperature table Q1 to the wire temperature calculated in step S6 (step S7). After executing step S7, the control unit 45 ends the processing for calculating the temperature of the wire W1.

### Processing for Calculating Temperature of Wire W2

The control unit 45 periodically executes the processing for calculating the temperature of the wire W2. The processing for calculating the temperature of the wire W2 is similar to the processing for calculating the temperature of the wire W1. The processing for calculating the temperature of the wire W2 can be described by replacing the output unit H1, the A/D conversion unit J1, and the wire W1 with the output unit H2, the A/D conversion unit J2, and the wire W2, respectively in the description of the processing for calculating the temperature of the wire W1.

Therefore, the control unit 45 acquires the wire currents of the two wires W1 and W2, and calculates the temperatures of the two wires W1 and W2 based on the two acquired wire currents.

### Processing for Controlling Power Supply to Load B1

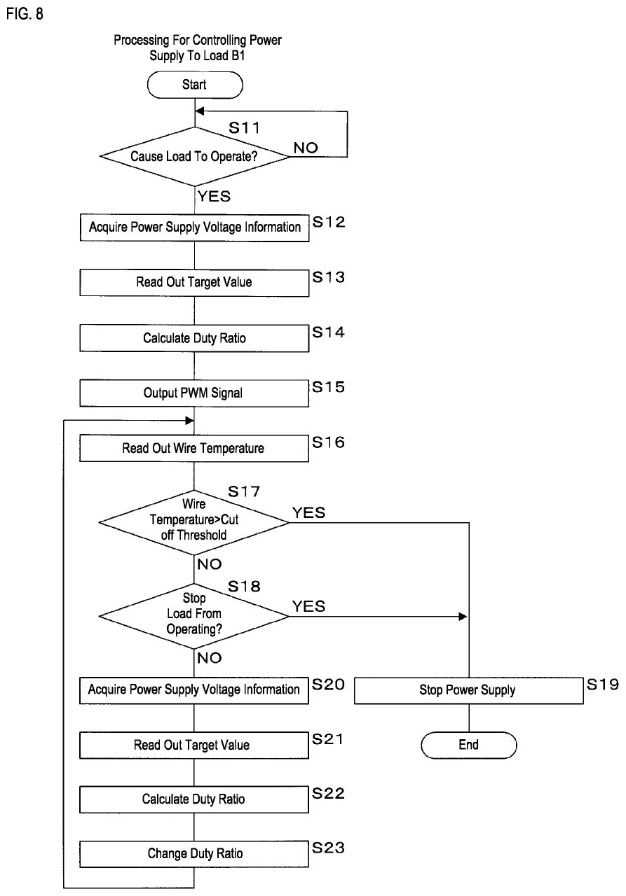

FIG. 8 is a flowchart illustrating a procedure of processing for controlling power supply to the load B1. In the processing for controlling power supply to the load B1, first, the control unit 45 determines whether or not the load B1 is caused to start operating (step S11). In step S11, if the communication unit 43 has received instruction data for instructing that the two loads B1 and B2 be caused to start operating, the control unit 45 determines that the load B1 is caused to start operating. If the communication unit 43 has not received instruction data for instructing that the two loads B1 and B2 be caused to start operating, the control unit 45 determines that the load B1 is not caused to start operating. Upon determining that load B1 is not caused to start operating (S11: NO), the control unit 45 again executes step S11, and waits until the communication unit 43 receives instruction data for instructing that the two loads B1 and B2 be caused to start operating.

Upon determining that the load B1 is caused to start operating (S11: YES), the control unit 45 acquires power supply voltage information from the A/D conversion unit 40 (step S12), and reads out the target value of the load B1 from the target value table Q2 (step S13). Next, the control unit 45 calculates the duty ratio of the PWM signal with which the average value of the related value matches the target value read out in step S13, based on the power supply voltage value indicated by the power supply voltage information acquired in step S12 (step S14).

For example, when the load B1 is a head light including LEDs, the luminance of the load B1 increases as the average value of the wire current of the wire W1 increases. When the load B1 is a head light including LEDs, the related value is a wire current. The target value is represented by a current value. The wire current flowing when the switch 30 of the switching device G1 is on is denoted as a switch current. The switch current is calculated based on the power supply voltage indicated by the power supply voltage information acquired in step S12. The control unit 45 divides the target value read out in step S13 by the switch current calculated based on the power supply voltage value. Accordingly the duty ratio of the PWM signal is calculated.

For example, when the load B1 is a head light including an incandescent lamp, the luminance of the load B1 increases as the average value of power supplied to the load B1 increases. When the load B1 is a head light including an incandescent lamp, the related value is the power supplied to the load B1. The target value is also represented by power. The power supplied to the load B1 when the switch 30 of the switching device G1 is on is denoted as load power. The load power is calculated based on the power supply voltage indicated by the power supply voltage information acquired in step S12. The control unit 45 divides the target value read out in step S13 by the load power calculated based on the power supply voltage value. Accordingly, the duty ratio of the PWM signal is calculated.

For example, when the load B1 is a windshield wiper motor, the rotational speed of the load B1 increases as the average value of a voltage applied to the load B1 increases. When the load B1 is a windshield wiper motor, the related value is a voltage value of a voltage applied to the load B1. The target value is also represented by a voltage value. The voltage applied to the load B1 when the switch 30 of the switching device G1 is on is denoted as a load voltage. The load voltage is calculated based on a power supply voltage value indicated by the power supply voltage information acquired in step S12. The control unit 45 divides the target value read out in step S13 by a load voltage calculated based on the power supply voltage value. Accordingly, the duty ratio of the PWM signal is calculated.

Next, the control unit 45 instructs the output unit H1 to output a PWM signal with the duty ratio calculated in step S14 (step S15). With this, the driving circuit 31 of the switching device G1 performs PWM control on the switch 30 according to the PWM signal voltage. The duty ratio of the PWM control performed by the driving circuit 31 is adjusted to the duty ratio calculated in step S14. As a result of the driving circuit 31 performing PWM control on the switch 30, a current flows through the wire W1, and the average value of the related values is adjusted to the target value.

After executing step S15, the control unit 45 reads out a wire temperature of the wire W1 shown in the wire temperature table Q1 (step S16). Next, the control unit 45 determines whether or not the wire temperature of the wire W1 read out in step S16 is a cutoff threshold or more (step S17). If the control unit 45 determines that the wire temperature of the wire W1 is less than the cutoff threshold (S17: NO), the control unit 45 determines whether or not the load B1 is caused to stop operating (step S18). In step S18, if the communication unit 43 has received instruction data for instructing that the two loads B1 and B2 be caused to stop operating, the control unit 45 determines to stop the load B1 from operating. If the communication unit 43 has not received instruction data for instructing that the two loads B1 and B2 be caused to stop operating, the control unit 45 determines that the load B1 is not to be stopped from operating.

If the control unit 45 determines that the wire temperature of the wire W1 is the cutoff threshold or more (S17: YES), or determines to stop the load B1 from operating (S18: YES), the control unit 45 stops power supply to the load B1 through the wire W1 by causing the output unit H1 to output a low-level voltage (step S19). When the output unit H1 outputs a low-level voltage, the driving circuit 31 of the switching device G1 switches the switch 30 off With this, power supply to the load B1 stops. After executing step S19, the control unit 45 ends the processing for controlling power supply to the load B1.

If the power supply control processing is ended after determining to stop the load B1 from operating, the control unit 45 again executes the power supply control processing. If the power supply control processing is ended after it has been determined that the wire temperature is the cutoff threshold or more, the control unit 45 will not restart the power supply control processing until a predetermined condition is satisfied. The predetermined condition is that the wire temperature has decreased to a value close to the environmental temperature, for example.

If the control unit 45 has determined not to stop the load B1 from operating (S18: NO), the control unit 45 acquires power supply voltage information from the A/D conversion unit 40 (step S20). Next, the control unit 45 reads out a target value of the switching device G1 shown in the target value table Q2 (step S21). Similarly to step S14, the control unit 45 calculates the duty ratio of the PWM signal with which the average value of the related value matches the target value read out in step S21, based on the power supply voltage value indicated by the power supply voltage information acquired in step S20 (step S22). Next, the control unit 45 changes the duty ratio of the PWM signal output by the output unit H1 to the duty ratio calculated in step S22 (step S23), and again executes step S16.

As described above, if the communication unit 43 has not received instruction data for instructing that the two loads B1 and B2 be caused to stop operating, in a state in which the wire temperature is less than the cutoff threshold, the duty ratio of the PWM signal is adjusted such that the average value of the related value matches the target value, based on the power supply voltage value. It is assumed that the positive electrode of the DC power supply 12 is connected to a starter of a vehicle C. The DC power supply 12 supplies power to the starter. As a result of causing the starter to start operating, when the power supply voltage of the DC power supply 12 has decreased, the duty ratio increases, and the average value of the related value is kept at the target value. As a result of causing the starter to stop operating, when the power supply voltage of the DC power supply 12 increases, the duty ratio decreases, and the average value of the related values is kept at the target value.

Also, if the wire temperature has increased to a temperature that is the cutoff threshold or more, the driving circuit 31 of the switching device G1 switches the switch 30 off With this, the current flow through the wire W1 stops, and the wire temperature of the wire W1 decreases. Therefore, the temperature of the wire W1 is prevented from increasing to an abnormally high temperature.

### Processing for Controlling Power Supply to Load B2

The control unit 45 executes processing for controlling power supply to the load B2 similarly to the processing for controlling power supply to the load B1. The load B1 other than the load B1 included in the phrase “loads B1 and B2” is replaced with a load B2 in the description of the processing for controlling power supply to the load B1. Furthermore, the switching device G1, the output unit H1, and the wire W1 are respectively replaced with a switching device G2, an output unit H2, and a wire W2. Accordingly, the processing for controlling power supply to the load B2 can be described. Therefore, the control unit 45 calculates, for the driving circuit 31 of the switching device G2, the duty ratio of the PWM signal (PWM control) with which the average value of the related values matches the target value, based on the power supply voltage value indicated by the acquired power supply voltage value information, and changes the duty ratio in the PWM control performed by the driving circuit 31 to the calculated duty ratio. The effects of the processing for controlling power supply to the load B2 are similar to the effects of the processing for controlling power supply to the load B1.

The control unit 45 causes currents to flow through the two wires W1 and W2 by executing step S15 in the processing for controlling power supply to the loads B1 and B2. Also, the control unit 45 executes steps S17 and S18 in the processing for controlling power supply to the loads B1 and B2. Accordingly, if one of the wire temperatures of the two wires W1 and W2 is a cutoff threshold or more, the control unit 45 stops the current flow through a wire whose wire temperature is the cutoff threshold or more.

When the communication unit 43 receives instruction data for instructing that the two loads B1 and B2 be caused to start operating, the control unit 45 causes the output units H1 and H2 to output PWM signals, in step S15 of the processing for controlling power supply to the loads B1 and B2. Accordingly, the two loads B1 and B2 start operating simultaneously. When the communication unit 43 receives instruction data for instructing that the two loads B1 and B2 be caused to stop operating, the control unit 45 causes the output units H1 and H2 to output a low-level voltage, in step S19 in the processing for controlling power supply to the loads B1 and B2. Accordingly, the two loads B1 and B2 stop operating simultaneously.

### Current Reduction Processing

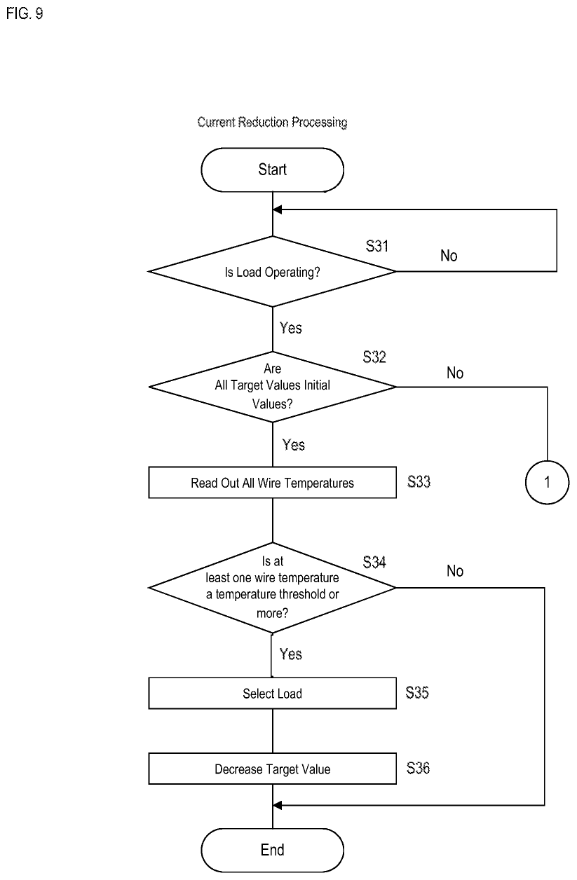

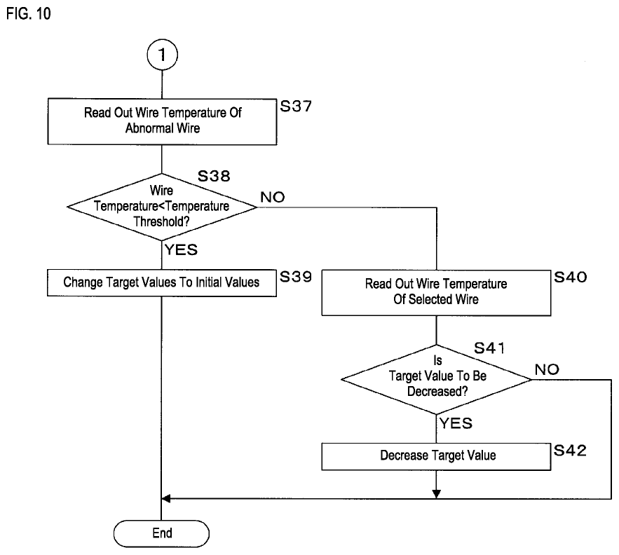

FIGS. 9 and 10 are flowcharts illustrating procedures of current reduction processing. In the current reduction processing, the control unit 45 determines whether or not at least one of the two loads B1 and B2 is operating (step S31). In step S31, if at least one of the two output units H1 and H2 is outputting a PWM signal, the control unit 45 determines that at least one load is operating. If the two output units H1 and H2 are keeping the output voltages at a low-level voltage, the control unit 45 determines that the two loads B1 and B2 are not operating. Upon determining that the two loads are not operating (S31: NO), the control unit 45 again executes step S31, and waits until at least one of the two loads B1 and B2 starts operating.

Upon determining that at least one load is operating (S31: YES), the control unit 45 determines whether or not all of the target values shown in the target value table Q2 are initial values (step S32). Upon determining that all of the target values are initial values (S32: YES), the control unit 45 reads out all of the wire temperatures shown in the wire temperature table Q1 (step S33). Next, the control unit 45 determines whether or not at least one of the wire temperatures read out in step S33 is a temperature threshold or more (step S34). The temperature threshold is a fixed value, and is stored in the storage unit 44 in advance. The temperature threshold is smaller than the cutoff threshold.

Upon determining that at least one of the wire temperatures is the temperature threshold or more (S34: YES), the control unit 45 selects the load, out of all of the loads B1 and B2, that is connected to a normal wire whose wire temperature is less than the temperature threshold (step S35). The normal wire is one of the wires W1 and W2. Note that, if all of the wire temperatures are the temperature threshold or more, the control unit 45 selects one of the loads B1 and B2, in step S35.

The wire connected to the load selected in step S35 is denoted as a selected wire. The selected wire is usually a normal wire. A wire whose wire temperature is the temperature threshold or more, at the point in time at which the control unit 45 determines that at least one of the wire temperatures is the temperature threshold or more is denoted as an abnormal wire.

Next, the control unit 45 reduces, in the target value table Q2, the target value of the load selected in step S35 (step S36). When the control unit 45 reduces the target value of the load B1, for example, the duty ratio of the PWM signal output by the output unit H1 decreases simultaneously as the target value decreases, unless the power supply voltage changes. Accordingly, the duty ratio in the PWM control performed by the driving circuit 31 of the switching device G1 decreases. As a result, the average value of the wire current of the selected wire decreases. When the power supply voltage value is constant, as the target value decreases, the duty ratio of a PWM signal decreases.

Upon determining that no wire temperature is the temperature threshold or more (S34: NO), after executing step S36, the control unit 45 ends the current reduction processing.

Upon determining that at least one of the target values is not the initial value (S32: NO), the control unit 45 reads out the wire temperature of an abnormal wire, from the wire temperature table Q1 (step S37). Next, the control unit 45 determines whether or not the wire temperature of the abnormal wire read out in step S37 is less than the temperature threshold (step S38). Upon determining that the wire temperature of the abnormal wire is less than the temperature threshold (S38: YES), the control unit 45 changes all of the target values to initial values (step S39), and ends the current reduction processing.

Accordingly, after decreasing the target value of the load connected to the selected wire to a value less than the initial value, if the wire temperature of the abnormal wire has decreased to a temperature less than the temperature threshold, the control unit 45 returns the target value to the initial value. When the target value is returned to the initial value, the average value of the wire currents of the selected wire increases, as long as the power supply voltage value of the DC power supply 12 is a fixed value. The fact that the wire temperature of an abnormal wire decreases to a temperature less than the temperature threshold indicates that the abnormal wire has returned to a normal wire.

Upon determining that the wire temperature of the abnormal wire is the temperature threshold or more (S38: NO), the control unit 45 reads out, from the wire temperature table Q1, the wire temperature of the selected wire (step S40), and determines whether or not the target value that is less than the initial value is to be further reduced, based on the read-out wire temperature of the selected wire (step S41). In step S41, if the wire temperature of the selected wire is the temperature threshold or more, the control unit 45 determines that the target value is to be further reduced, for example. If the wire temperature of the selected wire is less than the temperature threshold, the control unit 45 determines that the target value is not to be further reduced.

Upon determining that the target value is to be further reduced (S41: YES), the control unit 45 further reduces the target value that is less than the initial value (step S42). Upon determining that the target value is not to be further reduced (S41: NO), or after executing step S42, the control unit 45 ends the current reduction processing.

After ending the current reduction processing, the control unit 45 again executes the current reduction processing, and waits until at least one of the loads B1 and B2 starts operating.

### Exemplary Operations of Individual ECU 11a

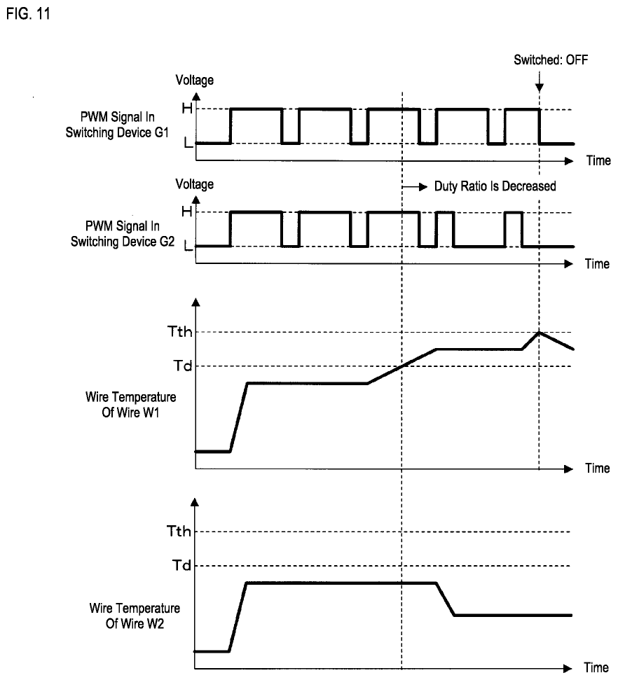

FIG. 11 is a timing chart illustrating exemplary operations of the individual ECU 11a. FIG. 11 shows the voltage transition of PWM signals output to the driving circuits 31 of the switching devices G1 and G2 and the wire temperature transition of the wires W1 and W2. Here, it is assumed that the power supply voltage is kept constant. In FIG. 11, a high-level voltage and a low-level voltage are respectively denoted as “H” and “L”. The cutoff threshold and the temperature threshold are respectively denoted as Tth and Td.

When the two output units H1 and H2 of the microcomputer 20 outputs PWM signals to the driving circuits 31 of the switching devices G1 and G2, power is supplied to the loads B1 and B2 through the wires W1 and W2, and the wire temperatures of the wires W1 and W2 increase. When the power supply voltage is constant, the wire temperatures of the wires W1 and W2 usually stabilize at values less than the temperature threshold Td, as shown in FIG. 11.

Assume that an anomaly has occurred, and the wire temperature of the wire W1 has increased. If the wire temperature of the wire W1 has increased to a temperature that is the temperature threshold Td or more, the control unit 45 selects the switching device G2, in step S35 of the current reduction processing, and decreases the duty ratio of the PWM signal output by the output unit H2 to the driving circuit 31 of the switching device G2. With this, the wire temperature of the wire W2 decreases to a lower temperature. Accordingly, the likelihood that the wire temperature of the wire W2 will increase to a temperature that is the cutoff threshold or more is reduced.

If the wire temperature of the wire W1 increases to a temperature that is the cutoff threshold or more, the control unit 45 executes step S19 of the processing for controlling power supply to the load B1, and the output unit H1 outputs a low-level voltage to the driving circuit 31 of the switching device G1. With this, the driving circuit 31 of the switching device G1 switches the switch 30 off. Accordingly, the current flow through the wire W1 stops, and the wire temperature of the wire W1 decreases.

### Effects of Individual ECU 11a

When the wire temperature of one of the wires W1 and W2 has increased to a temperature that is the temperature threshold or more, the individual ECU 11a selects a normal wire as a selected wire, and decreases the average value of the wire current of the selected wire. Therefore, the likelihood that the wire temperature of the selected wire will increase to a high temperature that is the cutoff threshold or more is low. As a result, the likelihood that the wire temperatures of all of the wires W1 and W2 will increase to a high temperature is low.

Also, after reducing the average value of the wire current of the selected wire, a determination is made as to whether or not the average value of the wire current of the selected wire is to be further reduced based on the wire temperature of the selected wire. Therefore, the likelihood that the temperature of the selected wire will increase to a high temperature that is the cutoff threshold or more is further reduced.

Moreover, if the wire temperature of one of the wires W1 and W2 has increased to a temperature that is the cutoff threshold or more, current flow through the wire whose wire temperature is the cutoff threshold or more is stopped. Accordingly, the wire temperature will not increase to an abnormally high temperature.

It is possible that, if the wire temperatures of the wires W1 and W2 have increased to a temperature that is the cutoff threshold or more, all of the loads B1 and B2 will unexpectedly stop operating. However, by reducing the average value of the wire current of the selected wire, the likelihood that both of the loads B1 and B2 will unexpectedly stop operating is low.

### Second Embodiment

In the control system 1 in the first embodiment, the number of loads to which the DC power supply 12 supplies power is two. However, the number of loads to which the DC power supply 12 supplies power may be three or more.

The differences of the second embodiment from the first embodiment will be described below. The configurations other than the configurations described below are in common with the first embodiment. Therefore, the constituent units that are in common with the first embodiment are given the same reference numerals as the first embodiment, and the description thereof will be omitted.

### Configuration of Individual ECU 11a

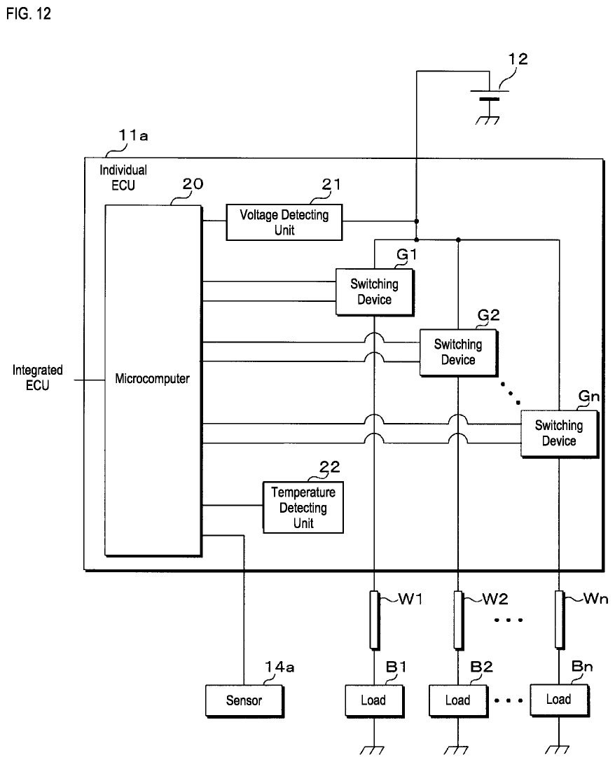

FIG. 12 is a block diagram illustrating the main configuration of an individual ECU 11a in the second embodiment. When a control system 1 in the second embodiment is compared with the control system 1 in the first embodiment, the number of loads is different. The control system 1 in the second embodiment includes n loads B1, B2, . . . , Bn. Here, n is an integer of three or more. The individual ECU 11a is connected to one end of a wire Wi. The other end of the wire W1 is connected to one end of the load Bi. The other end of the load B1 is grounded. Here, i is any integer in a range that is three or more and is n or smaller. Therefore, i may be any of 3, 4, . . . , n.

The DC power supply 12 supplies power to the n loads B1, B2, . . . , Bn through the n wires W1, W2, . . . , Wn. The load B1 operates similarly to the load B1. All of the loads B1, B2, . . . , Bn are the same type of load. A first example of the related value is a current value of the current supplied to a load Bu. A second example of the related value is a voltage value of the voltage applied to the load Bu. A third example of the related value is power supplied to the load Bu. Here, u is any integer in a range that is one or more and is n or smaller. Therefore, u may be any of 1, 2, . . . , n.

The individual ECU 11a controls power supply to the n loads B1, B2, . . . , Bn through the n wires W1, W2, . . . , Wn. The individual ECU 11a controls operations of the n loads B1, B2, . . . , Bn by controlling power supply to the n loads B1, B2, . . . , Bn.

The integrated ECU 10 determines the operations of the n loads B1, B2, . . . , Bn, based on one or more pieces of vehicle data received from at least one of the individual ECU 11a and the plurality of individual ECUs 11b. The integrated ECU 10 transmits instruction data for instructing the determined operations to the individual ECU 11a. The instruction data to be transmitted to the individual ECU 11a indicates whether the n loads B1, B2, . . . , Bn are to start operating or stop operating.

Upon receiving instruction data for instructing that the n loads B1, B2, . . . , Bn be caused to start operating, the individual ECU 11a causes the n loads B1, B2, . . . Bn to start operating simultaneously. Upon receiving instruction data for instructing that the n loads B1, B2, . . . , Bn be caused to stop operating, the individual ECU 11a causes the n loads B1, B2, . . . , Bn to stop operating simultaneously. As described above, “simultaneously” does not only mean simultaneously in a strict sense. “Simultaneously” also means substantially simultaneously.

When the individual ECU 11a in the second embodiment is compared with the individual ECU 11a in the first embodiment, the number of switching devices is different. The individual ECU 11a in the second embodiment includes n switching devices G1, G2, . . . , Gn. A switching device Gi is configured similarly to the switching device G1. The drain and source of the switch 30 of the switching device Gi are respectively connected to the positive electrode of a DC power supply 12 and one end of the wire Wi.

A microcomputer 20 outputs a PWM signal or a low-level voltage to a driving circuit 31 of the switching device Gi. The configuration of the switching device Gi can be described by replacing the switching device G1 and the wire W1 with a switching device Gi and a wire Wi, respectively, in the description of the configuration of the switching device G1. Therefore, the current value information output from the switching device Gi indicates the wire current of a current flowing through the wire Wi.

When the switch 30 of the switching device Gi is on, a current flows from the positive electrode of the DC power supply 12 through the switch 30 and the wire Wi. Therefore, n switches 30 are respectively disposed on current paths of currents flowing through the n wires W1, W2, . . . , Wn. In the switching device Gi, the driving circuit 31 switches the switch 30 on or off. The driving circuit 31 of the switching device Gi functions as a switching circuit.

### Configuration of Microcomputer 20

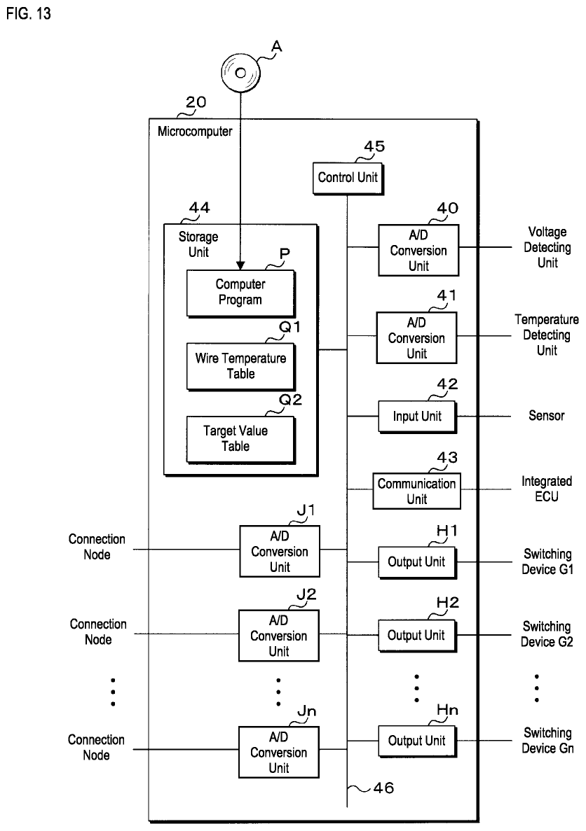

FIG. 13 is a block diagram illustrating the main configuration of the microcomputer 20. When the microcomputer 20 in the second embodiment is compared with the microcomputer 20 in the first embodiment, the number of output units and A/D conversion units is different. The microcomputer 20 in the second embodiment includes n output units H1, H2, . . . , Hn and n A/D conversion units J1, J2, . . . , Jn.

A communication unit 43 transmits vehicle data to the integrated ECU 10 in accordance with an instruction from the control unit 45. The communication unit 43 receives instruction data for instructing that the n loads B1, B2, . . . , Bn be caused to start or stop operating from the integrated ECU 10.

An output unit Hi outputs a PWM signal to the driving circuit 31 of the switching device Gi in accordance with the instruction from the control unit 45. The duty ratio of the PWM signal output by the output unit Hi is adjusted by the control unit 45. Furthermore, the output unit Hi outputs a low-level voltage to the driving circuit 31 of the switching device Gi in accordance with the instruction from the control unit 45.

Analog current value information is input to an A/D conversion unit Ji from a connection node of the switching device Gi. The A/D conversion unit Ji converts the input analog current value information to digital current value information. The control unit 45 acquires the digital current value information from the A/D conversion unit Ji. The current value information acquired from the A/D conversion unit Ji indicates the wire current of the wire Wi.

The control unit 45 executes, in parallel, vehicle data transmission processing, n sets of temperature calculation processing, n sets of power supply control processing, current reduction processing and the like, by executing a computer program P. In the n sets of temperature calculation processing, the wire temperatures of the wires W1, W2, . . . , Wn are calculated. In the n sets of power supply control processing, power supply to the loads B1, B2, . . . , Bn are controlled. In the current reduction processing, the wire currents of k wires, of the wires W1, W2, . . . , Wn, are reduced. Here, k is an integer in a range that is two or more and is less than n.

In a wire temperature table Q1, wire temperatures of the n wires W1, W2, . . . , Wn are shown. The wire temperatures shown in the wire temperature table Q1 are changed by the control unit 45. In a target value table Q2, n target values for the n loads B1, B2, . . . , Bn, and initial values of the n target values are shown. The n target values shown in the target value table Q2 are changed by the control unit 45.

### Processing for Calculating Temperature of Wire Wi

The control unit 45 periodically executes the processing for calculating the temperature of the wire Wi. The processing for calculating the temperature of the wire Wi is similar to the processing for calculating the temperature of the wire W1. The processing for calculating the temperature of the wire Wi can be described by replacing the output unit H1, the A/D conversion unit J1, and the wire W1 with an output unit Hi, ab A/D conversion unit Ji, and a wire Wi, respectively in the description of the processing for calculating the temperature of the wire W1.

Therefore, the control unit 45 acquires wire currents of the n wires W1, W2, . . . , Wn, and calculates the temperatures of the n wires W1, W2, . . . , Wn, based on the acquired n wire currents.

### Processing for Controlling Power Supply to Loads B1 and B2

In step S11 in processing for controlling power supply to the loads B1 and B2, the control unit 45 determines whether or not the load B1 or the load B2 is caused to start operating, based on whether or not the communication unit 43 has received instruction data for instructing that the n loads B1, B2, . . . , Bn be caused to start operating, similarly to the first embodiment. In step S18, the control unit 45 determines whether or not the load B1 or the load B2 is to be caused to stop operating, based on whether or not the communication unit 43 has received instruction data for instructing that the n loads B1, B2, . . . , Bn be caused to stop operating, similarly to the first embodiment.

### Processing for Controlling Power Supply to Load Bi

The control unit 45 executes processing for controlling power supply to the load Bi, similarly to the processing for controlling power supply to the load B1. In the description of the processing for controlling power supply to the load B1, the load B1 other than the load B1 included in the phrase “loads B1, B2, . . . , Bn” is replaced with the load Bi. Moreover, the switching device G1, the output unit H1, and the wire W1 are respectively replaced with a switching device G1, an output unit Hi, and a wire Wi. With this, the processing for controlling power supply to the load B1 can be described. Therefore, the control unit 45 calculates, for the driving circuit 31 of the switching device Gi, the duty ratio of the PWM signal (PWM control) with which the average value of the related values matches the target value, based on the power supply voltage value indicated by the acquired power supply voltage value information, and changes the duty ratio in the PWM control performed by the driving circuit 31 to the calculated duty ratio. The effects of the processing for controlling power supply to the load B1 are similar to the effects of the processing for controlling power supply to the load B1.

The control unit 45 causes currents to flow through the n wires W1, W2, . . . , Wn by executing step S15 in the processing for controlling power supply to the loads B1, B2, . . . , Bn. Also, the control unit 45 executes steps S17 and S19 in the processing for controlling power supply to the loads B1, B2, . . . , Bn. Accordingly, if one of the wire temperatures of the n wires W1, W2, . . . , Wn is a cutoff threshold or more, the control unit 45 stops current flow through the wire whose wire temperature is the cutoff threshold or more.

When the communication unit 43 receives instruction data for instructing that the n loads B1, B2, . . . , Bn be caused to start operating, the control unit 45 causes output units H1. H2, . . . , Hn to output PWM signals, in step S15 in the processing for controlling power supply to the loads B1, B2, . . . , Bn. Accordingly, the n loads B1, B2, . . . , Bn start operating simultaneously. When the communication unit 43 receives instruction data for instructing that the n loads B1, B2, . . . , Bn be caused to stop operating, the control unit 45 causes the output units H1. H2, . . . , Hn to output a low-level voltage, in step S19 in the processing for controlling power supply to the loads B1, B2, . . . , Bn. Accordingly the n loads B1, B2, . . . , Bn stop operating simultaneously.

### Current Reduction Processing

In step S31 of current reduction processing in the second embodiment, the control unit 45 determines whether or not at least one of the n loads B1, B2, . . . , Bn is operating, based on whether or not at least one of the n output units H1, H2, . . . , Hn is outputting a PWM signal, similarly to the first embodiment.

In step S35, the control unit 45 selects k loads connected to k normal wires whose wire temperature is less than the temperature threshold, from all of the loads B1, B2, . . . , Bn. Here, the k normal wires are included in the n wires W1, W2, . . . , Wn. Note that, when the number of normal wires is less than k, in step S35, the control unit 45 selects loads connected to all normal wires, and also selects loads of a number obtained by subtracting the number of selected normal wires from k, from one or more loads connected to one or more abnormal wires. In step S36, the control unit 45 reduces the target values of the k loads selected in step S35, in the target value table Q2.

In step S40, the control unit 45 reads out wire temperatures of the k selected wires in the wire temperature table Q1. In step S41, the control unit 45 determines whether or not the k target values that are less than the initial values are to be further reduced, based on the wire temperatures of the k selected wires that are read out in step S40. In step S41, if at least one of the wire temperatures of the k selected wires is the temperature threshold or more, the control unit 45 determines that the k target values are to be further reduced, for example. If the wire temperatures of the k selected wires are less than the temperature threshold, the control unit 45 determines that the k target values are not to be further reduced. In step S42, the control unit 45 further reduces the k target values that are less than the initial values.

Note that, in step S41, the control unit 45 may separately determine whether or not the k target values that are less than the initial values are to be further reduced, based on the wire temperatures of the k selected wires that are read out in step S40. In this case, in step S41, one or more target values that are to be reduced, from the k target values, are reduced.

Effects of individual ECU 11a

The individual ECU 11a in the second embodiment similarly achieves the effects achieved by the individual ECU 11a in the first embodiment. Therefore, the likelihood that the wire temperatures of all of the wires W1, W2, . . . , Wn will increase to a high temperature that is the cutoff threshold or more is low. Also, the likelihood that the wire temperatures of k wires, of the n wires W1, W2, . . . , Wn will increase to a temperature that is the cutoff threshold or more is low. Therefore, the likelihood that k loads will unexpectedly stop operating is low. The integer k is the minimum number of loads that are expected to continue operating, as long as operations are they are instructed to operate.

### Third Embodiment

In the first embodiment, when the control unit 45 causes the loads B1 and B2 to operate, the driving circuits 31 of the switching devices G1 and G2 perform PWM control. However, when the loads B1 and B2 are caused to operate, the switches 30 of the switching devices G1 and G2 may be fixed to on. That is, the duty ratio of the PWM control may be fixed to one.

The differences of the third embodiment from the first embodiment will be described below. The configurations other than the configurations described below are in common with the first embodiment. Therefore, the constituent units that are in common with the first embodiment are given the same reference numerals as the first embodiment, and the description thereof will be omitted.

### Configuration of Microcomputer 20 of Individual ECU 11a

Output units H1 and H2 each output a high-level voltage in addition to a PWM signal and a low-level voltage, in accordance with an instruction from a control unit 45. Driving circuits 31 of switching devices G1 and G2 each fix a switch 30 to on, when a high-level voltage is input.

### Processing for Controlling Power Supply to Load B1

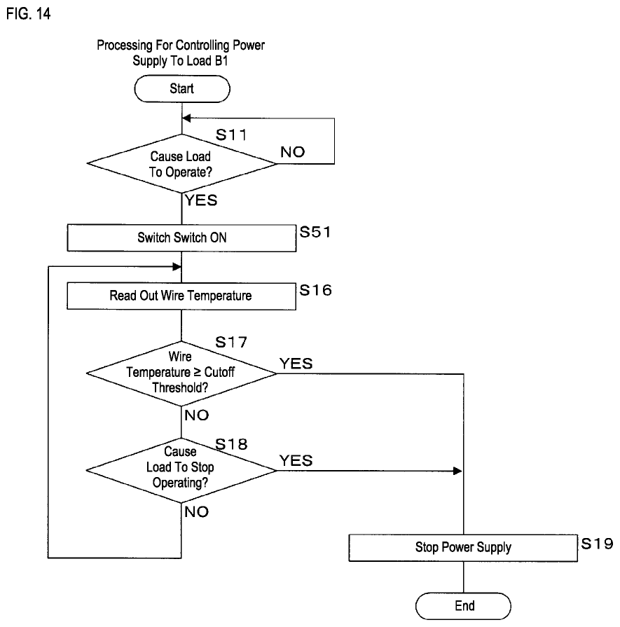

FIG. 14 is a flowchart illustrating a procedure of processing for controlling power supply to the load B1 in the third embodiment. In the processing for controlling power supply to the load B1 in the third embodiment, steps S11 and S16 to S19 are similarly executed, similarly to the processing for controlling power supply to the load B1 in the first embodiment. Therefore, the description of steps S11 and S16 to S19 will be omitted.

In the processing for controlling power supply to the load B1 in the third embodiment, if it is determined that the load B1 is to be caused to start operating (S11: YES), the control unit 45 causes the driving circuit 31 to switch the switch 30 of the switching device G1 on (step S51). In step S51, the control unit 45 instructs the output unit H1 to output a high-level voltage to the driving circuit 31 of the switching device G1. With this, the driving circuit 31 switches the switch 30 on. After executing step S51, the control unit 45 executes step S16.

If it is determined that the load B1 is not to be caused to stop operating (S18: NO), the control unit 45 executes step S16. Therefore, if the communication unit 43 does not receive instruction data for instructing that the two loads B1 and B2 be caused to stop operating, in a state in which the wire temperature is less than the cutoff threshold, the switch 30 is fixed to on.

### Processing for Controlling Power Supply to Load B2

The control unit 45 executes processing for controlling power supply to the load B2 similarly to the processing for controlling power supply to the load B1. The load B1 other than the load B1 included in the phrase “loads B1 and B2” is replaced with a load B2, in the description of the processing for controlling power supply to the load B1. Moreover, the switching device G1, the output unit H1, and the wire W1 are replaced with a switching device G2, an output unit H2, and a wire W2. With this, the processing for controlling power supply to the load B2 can be described.

As described above, the control unit 45 causes the driving circuits 31 of the switching devices G1 and G2 to switch the switches 30 on. Accordingly, currents flow through the wires W1 and W2.

### Processing for Calculating Temperature of Wires W1 and W2

Regarding step S4 of the processing for calculating the temperature of the wire W1, when the output unit H1 is outputting a high-level voltage, the duty ratio D in the formula [1] is one. Similarly, regarding step S4 of the processing for calculating the temperature of the wire W2, when the output unit H2 is outputting a high-level voltage, the duty ratio D in the formula [1] is one.

### Current Reduction Processing

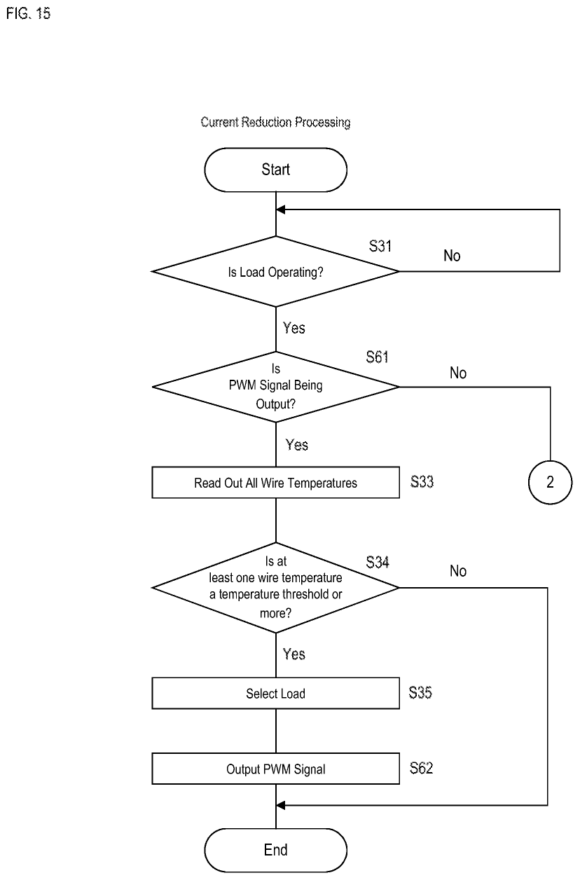

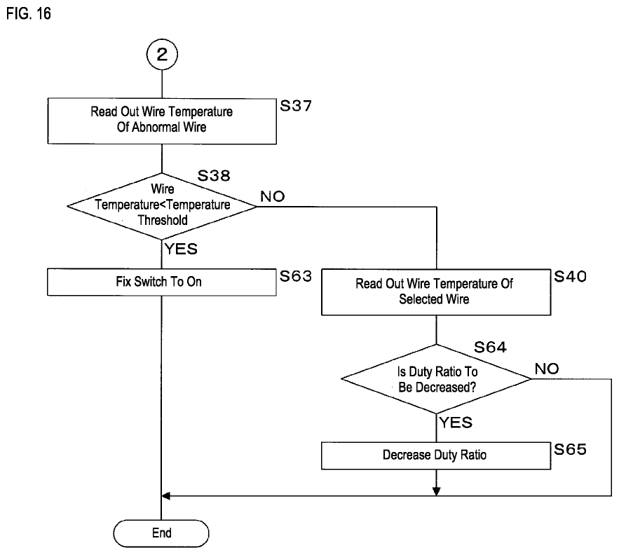

FIGS. 15 and 16 are flowcharts illustrating a procedure of current reduction processing. In the current reduction processing in the third embodiment, steps S31, S33 to S35, S37, S38, and S40 are similarly executed, similarly to the current reduction processing in the first embodiment. Therefore, the description of steps S31, S33 to S35, S37, S38, and S40 will be omitted.

In the current reduction processing in the third embodiment, upon determining that at least one of the two loads B1 and B2 is operating (S31: YES), the control unit 45 determines whether or not at least one of the two output units H1 and H2 is outputting a PWM signal (step S61). If it is determined that at least one of the two output units H1 and H2 is outputting a PWM signal (S61: YES), the control unit 45 executes step S33. If it is determined that the two output units are not outputting a PWM signal (S61: NO), the control unit 45 executes step S37.

After executing step S35, the control unit 45 instructs one of the output units H1 and H2 to cause the driving circuit 31 of a switching device, of the two switching devices G1 and G2, that corresponds to the load selected in step S35, to output a PWM signal (step S62). With this, the driving circuit 31 to which a PWM signal is input performs PWM control on the switch 30. As a result, the average value of the wire current of the selected wire decreases. Here, the duty ratio of the PWM signal is a preset value. Note that the duty ratio of the PWM signal may be a duty ratio calculated based on the target value shown in the target value table Q2 and the power supply voltage of the DC power supply 12, similarly to the first embodiment. After executing step S61, the control unit 45 ends the current reduction processing.

After ending the current reduction processing, the control unit 45 again executes the current reduction processing, and waits until at least one of the loads B1 and B2 starts operating.

Upon determining that the wire temperature of the abnormal wire is less than the temperature threshold (S38: YES), the control unit 45 instructs the driving circuits 31 of all of the switching devices G1 and G2 to fix the switches 30 to on (step S63). In step S63, the control unit 45 causes all of the output units H1 and H2 to output a high-level voltage. With this, all switches 30 are fixed to on. The average value of the wire current of the selected wire is increased. After executing step S63, the control unit 45 ends the current reduction processing.

After executing step S40, the control unit 45 determines whether or not the duty ratio of the PWM signal that one of the output units H1 and H2 is outputting is to be further reduced, based on the wire temperature of the selected wire that is read out in step S40 (step S64). In step S64, if the wire temperature of the selected wire is the temperature threshold or more, the control unit 45 determines that the duty ratio is to be further reduced, for example. If the wire temperature of the selected wire is less than the temperature threshold, the control unit 45 determines that the duty ratio is not to be further reduced.

If it is determined that the duty ratio is to be further reduced (S64: YES), the control unit 45 further reduces the duty ratio of the PWM signal (step S65). If it is determined that the duty ratio is not to be further reduced (S64: NO), or after executing step S65, the control unit 45 ends the current reduction processing.

After ending the current reduction processing, the control unit 45 again executes the current reduction processing, and waits until at least one of the loads B1 and B2 starts operating.

### Effects of Individual ECU 11a

The individual ECU 11a in the third embodiment similarly achieves effects that the individual ECU 11a in the first embodiment achieves, other than the effects obtained by changing the duty ratio of a PWM signal based on a power supply voltage. Therefore, the likelihood that the wire temperatures of all of the wires W1, W2, . . . , Wn will increase to a high temperature that is the cutoff threshold or more is low.

### Modifications

Similarly to the case where the configuration of the first embodiment is extended to a configuration in which the number of loads is n, in the second embodiment, the configuration of the third embodiment may be extended to a configuration in which the number of loads is n. In this case, in the second embodiment, the processing for controlling power supply to the loads B1, B2, . . . , Bn, the current reduction processing, and the like are executed similarly to the third embodiment. The instruction data is for instructing that the n loads B1, B2, . . . , Bn be caused to start or stop operating. In step S31 of the current reduction processing, the control unit 45 determines whether or not at least one of the n loads B1, B2, . . . , Bn is operating.

In step S35 of the current reduction processing, the control unit 45 selects k loads connected to k normal wires whose wire temperature is less than the temperature threshold, from all of the loads B1, B2, . . . , Bn, similarly to the second embodiment. Note that, when the number of normal wires is less than k, in step S35, the control unit 45 selects loads connected to all normal wires, and also selects loads of the number obtained by subtracting the number of selected normal wires from k, from one or more loads connected to one or more abnormal wires.

In step S62, after executing step S35, k output units of the output units H1. H2, . . . , Hn are instructed to cause the driving circuits 31 of k switching devices corresponding to the k loads selected in step S35 to output PWM signals. In step S63, the control unit 45 instructs the driving circuits 31 of all of the switching devices G1, G2, . . . , Gn to fix the switches 30 on.

In step S40, the control unit 45 reads out wire temperatures of the k selected wires, from the wire temperature table Q1. In step S64, the control unit 45 determines whether or not the duty ratios of the k PWM signals are to be further reduced based on the wire temperatures of the k selected wires that are read out in step S40. In step S64, if at least one of the wire temperatures of the k selected wires is the temperature threshold or more, the control unit 45 determines that the duty ratios of the k PWM signals are to be further reduced, for example. If the wire temperatures of the k selected wires are less than the temperature threshold, the control unit 45 determines that the duty ratios of the k PWM signals are not to be further reduced. In step S64, the control unit 45 further reduces the k PWM signals.

Note that, in step S64, the control unit 45 may separately determine whether or not the duty ratios of the k PWM signals are to be further reduced, based on the wire temperatures of the k selected wires that are read out in step S40. In this case, in step S64, the control unit 45 decreases the duty ratios of one or more PWM signals, of the duty ratios of the k PWM signals, that are to be decreased,

In the first to third embodiments, when the average value of a wire current of the selected wire is reduced, the average value of a wire current of an abnormal wire may also be decreased. Also, the method of adjusting the wire current is not limited to the method of adjusting the duty ratio in the PWM control. When a variable resistor is disposed on a current path, the wire current may also be adjusted by adjusting the resistance of the variable resistor. The device that calculates a wire temperature is not limited to the individual ECU 11a. For example, the integrated ECU 10 may also calculate the wire temperature. The power supply control device that controls power supply is not limited to the individual ECU 11a that communicates with the integrated ECU 10. The number of abnormal wires is not limited to one, and may also be two or more. When the number of abnormal wires is two or more, in step S38 of the current reduction processing, whether or not the wire temperatures of all of the abnormal wires are less than the temperature threshold is determined.

The number of sensors that are connected to each of the individual ECU 11a and the plurality of individual ECUs 11b is not limited to one, and may also be two or more. The number of actuators 13 connected to each individual ECU 11b is not limited to one, and may also be two or more.

The switch 30 is not limited to an N-channel FET, and may also be a semiconductor switch, a relay contact, or the like. Examples of the semiconductor switch include a P-channel FET, an IGBT (Insulated Gate Bipolar Transistor), and a bipolar transistor, in addition to the N-channel FET.

The first to third embodiments disclosed herein are illustrative in all aspects and should not be considered restrictive. The scope of the present disclosure is indicated by the scope of claims, not the above-mentioned meaning, and is intended to include all modifications within the meaning and scope equivalent to the scope of claims.

1. A power supply control device that controls power supply through a plurality of wires, comprising:
a processing unit configured to execute processing,
wherein the processing unit
causes currents to flow through the plurality of wires, and
if one wire temperature of the plurality of wires is a temperature threshold or more, reduces an average current value of a current flowing through a normal wire, of the plurality of wires, whose wire temperature is less than the temperature threshold.

2. The power supply control device according to claim 1,
wherein, when one of a plurality of wire temperatures is at a cutoff threshold or more, the processing unit stops current flow through a wire whose wire temperature is at the cutoff threshold or more, and
the temperature threshold is less than the cutoff threshold.

3. The power supply control device according to claim 1, further comprising:
a plurality of switches that are respectively disposed on current paths of currents flowing through the plurality of wires; and
a plurality of switching circuits configured to respectively switch the plurality of switches on or off,
wherein the processing unit causes currents to flow through wires by causing the switching circuits to perform PWM control on the respective switches to alternately switch on and off, and
reduces an average current value of a current flowing through the normal wire by reducing a duty ratio in the PWM control performed by the switching circuit of a switch corresponding to the normal wire.

4. The power supply control device according to claim 3,
wherein currents flow to a plurality of loads from a DC power supply through the plurality of wires, and
the processing unit
acquires a voltage value of the DC power supply,
calculates, with respect to each switching circuit, a duty ratio in the PWM control with which an average value of related values related to the load matches a target value, based on the acquired voltage value,
changes the duty ratio in the PWM control performed by the switching circuit to the calculated duty ratio,
reduces the duty ratio in the PWM control by reducing the target value of the load connected to the normal wire, and
the related value is a current value of a current flowing to a load, a voltage value of a voltage applied to a load, or power supplied to a load.

5. The power supply control device according to claim 1, further comprising:
a plurality of switches that are respectively disposed on current paths of currents flowing through the plurality of wires; and
a plurality of switching circuits configured to respectively switch the plurality of switches on or off,
wherein the processing unit
causes currents to flow through wires by causing the switching circuits to respectively switch the switches on, and
reduces an average current value of a current flowing through the normal wire by causing the switching circuit of a switch corresponding to the normal wire to perform PWM control to alternately switch the switch on and off.

6. The power supply control device according to claim 1,
wherein the processing unit, after reducing the average current value of the normal wire, if the wire temperature of an abnormal wire whose wire temperature has increased to a temperature that is the temperature threshold or more has decreased to a temperature less than the temperature threshold, increases the average current value of the normal wire.

7. The power supply control device according to claim 1,
wherein the processing unit, after reducing the average current value of the normal wire, determines whether or not the average current value of the normal wire is to be further reduced, based on the wire temperature of the normal wire.

8. The power supply control device according to claim 1,
wherein the processing unit
acquires current values of currents flowing through the plurality of wires, and
calculates a plurality of wire temperatures based on the plurality of acquired current values.

9. An in-vehicle control device that controls operations of a plurality of loads, comprising:
a receiving unit configured to receive instruction data for instructing that the plurality of loads be caused to start operating; and
a processing unit configured to execute processing,
wherein the processing unit,
when the receiving unit receives the instruction data, causes currents to flow to the plurality of loads through a plurality of wires, and
if one wire temperature of the plurality of wires has increased to a temperature that is a temperature threshold or more, reduces an average current value of a current flowing through a normal wire, of the plurality of wires, whose wire temperature is less than the temperature threshold.

10. A power supply control method that controls power supply through a plurality of wires, the method causing a computer to execute:
a step of causing currents to flow through the plurality of wires; and
a step of, if one wire temperature of the plurality of wires has increased to a temperature that is a temperature threshold or more, reducing an average current value of a current flowing through a normal wire, of the plurality of wires, whose wire temperature is less than the temperature threshold.
